(19) United States
(12) Patent Application Publication
(10) Pub. No.: US 2016/0000129 A1
(43) Pub. Date: Jan. 7, 2016

(54) GROUND BEEF AND GROUND CHICKEN COMPOSITION

(71) Applicant: Cluck Inc., New City, NY (US)

(72) Inventor: Steve Gold, New City, NY (US)

(21) Appl. No.: 14/320,711

(22) Filed: Jul. 1, 2014

(51) Int. Cl. A23L 1/317

(52) U.S. Cl. CPC A23L 1/3177; A23V 2002/00

(57) ABSTRACT

An edible food composition, including a combination of portions of ground beef and ground poultry; the combination having from 5-95% by weight of ground beef and 95%-5% by weight of ground poultry. The composition contains ground beef derived from the chuck section of a cow and the ground poultry is derived from the leg of a chicken. The combination elutes a volatile signature of nonanal in the raw state similar to that of poultry and elutes a volatile signature of hexanal and methyl butenal in the cooked state. The combination has approximately 52% less fat, 35% less calories and 55% less saturated fat than that of ground beef. The composition may be in a raw state or a cooked state. The ground beef and ground poultry is derived from grass fed cows and chickens which are free of antibiotics, hormones and genetically modified organisms. The ground beef and ground poultry is free of additives, fillers and preservatives.

### FIELD OF THE EMBODIMENTS

This invention relates to a ground beef and ground chicken composition with improved health, physical and chemical properties.

### BACKGROUND OF THE EMBODIMENTS

The United States patent office has issued patents that disclose mere mixes of ingredients when those ingredients create a resulting product that has improved health and physical characteristics. For example, U.S. Pat. No. 4,137,336 discloses a dietetic cookie mix which is combined with water and baked to produce a batch of cookies. U.S. Pat. No. 7,255,889 discloses a chicken soup mix composition and a process for preparing the same. Unlike these patents, the present application is a combination of meats that when combined either in the raw or cooked state yield unexpected results.

As Americans age, they are increasingly turning to healthier foods as part of a more comprehensive approach to managing their wellness. There is a global trend to eat “better for you” products. This includes products that are natural, organic, gluten free, and free from non-genetically modified organisms. Burger consumption is also on the rise, due in part to the increased availability and variety of high quality and customizable burgers inspired by the success of the “better-burger” category. The commercial success of all beef burgers in the market place has created a need for a healthy alternative. The healthy alternative disclosed in the present application is the use of ground poultry as part of the composition. An example of related art is US Patent Publication No. 2012/0171331 which discloses a ground beef or processed meats with improved health and rheological characteristic. However, US 2012/0171331 does not contain any or significant amount of ground poultry.

Standardized U.S. and global guidelines for ground beef that consumers are eating contain fat totals upwards of 30 grams, saturated fat upwards of 12 grams, and cholesterol upwards of 200 milligrams per 4 ounce. The present application's composition relates to a composition with significantly less totals of fat, saturated fat and cholesterol.

### SUMMARY OF THE EMBODIMENTS

The embodiments of the present application relate generally to a ground beef and ground poultry composition having unexpected and improved characteristics than that of ground beef or ground poultry individually, including for example a lower fat content, lower saturated fat content, lower calorie contents, additional antioxidant contents, dietary fiber content, and reduction of negative cholesterol.

The present application generally relates to an edible food composition, including a combination of portions of ground beef and ground poultry where the combination has 5-95% by weight of ground beef and 95%-5% by weight of ground poultry. The composition includes ground beef derived from the chuck section of a cow and the ground poultry is derived from the leg of a chicken. The composition may include ground beef derived from various sections of the cow and the ground poultry may be derived from various parts of a chicken.

The combination of ground beef and ground poultry may be comprised of 10%-90% of ground beef and 90%-10% of ground poultry by weight, 20%-80% of ground beef and 80%-20% of ground poultry by weight, 30-%-70% of ground beef and 70%-30% of ground poultry by weight, and 40%-60% of ground beef and 40%-60% of ground poultry by weight. In another embodiment of the application, the composition may be comprised equal portions of ground beef and ground poultry by weight. In another embodiment of the present application, the combination may be comprised of unequal portions of ground beef and ground poultry by weight.

The combination elutes a volatile signature of nonanal in the raw state similar to that of poultry and elutes a volatile signature of hexanal and methyl butenal in the cooked state. The combination has approximately 52% less fat, 35% less calories and 55% less saturated fat than that of a typical all ground beef burger. The composition may be in a raw state or a cooked state. The ground beef and ground poultry is derived from grass fed cows and chickens which are free of antibiotics, hormones and genetically modified organisms. The ground beef and ground poultry is free of additives, fillers and preservatives.

The composition contains 0% Trans fatty acids which are unsaturated artificially created fats. The composition is high in omegas 3, vitamin A and E, oleic and linoleic acids, retinol and calcium. The composition is 100% all natural and therefore contains no additives, fillers or preservatives or any kind. The composition is antibiotic and hormone free. The cows and chickens are organic and humanely raised. The cows and chickens are grass fed and are also free from genetically modified organisms.

The composition has a hardness and chewiness similar to that of beef. The composition in a cooked state has a shear force and shear energy lower than that of cooked beef or cooked poultry. The composition in its cooked state is lower in positive force and positive area than a linear combination of beef and poultry. The composition may be frozen or refrigerated.

### BRIEF DESCRIPTION OF THE DRAWINGS

FIG. 1 shows a Gas Chromatography/Mass Spectrometry headspace of a typical raw ground beef sample.

FIG. 2 shows a Gas Chromatography/Mass Spectrometry headspace of a typical raw ground poultry sample.

FIG. 3 shows a Gas Chromatography/Mass Spectrometry headspace of the composition in the raw state.

FIG. 4 shows a Gas Chromatography/Mass Spectrometry headspace of a typical cooked ground beef sample.

FIG. 5 shows a Gas Chromatography/Mass Spectrometry headspace of a typical cooked ground poultry sample.

FIG. 6 shows a Gas Chromatography/Mass Spectrometry headspace of the composition in a cooked state.

### DESCRIPTION OF THE PREFERRED EMBODIMENTS

The preferred embodiments of the present invention will now be described with reference to the drawings. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto. As used herein, poultry may include chicken.

The preferred embodiment of the present application includes a composition which may be comprised of 50% certified antibiotic free poultry, by weight, which may be derived from the leg of the chicken. The poultry may be fresh or fresh frozen (quickly frozen while still fresh). The composition also is comprised of 50% ground beef by weight, which is derived from an 80% antibiotic free grass fed cow. The beef may be chuck which consists of parts of the neck, shoulder blade and upper arm of a cow. The beef may be fresh or fresh frozen. The combined 50% percent beef and 50% poultry, of equal weights, is grounded and combined into 4 ounce circular patties with a diameter of approximately 4 inches and a thickness of approximately 0.5 inches. In another embodiment of the present application, the beef and chicken may be derived from different parts of the cow and chicken. In another embodiment, the composition may combined into larger or thicker patties. The composition contains approximately 8 grams of fat, 3 grams of saturated fat, 85 milligrams of cholesterol, 170 calories and 70 calories from fat per 4 ounce serving. The cows and chickens are farm raised in the United States but may be raised in similar locations and conditions.

The method for preparing the composition includes, initially passing the equal portion of poultry and beef through a 3/16″ grind plate, blending the ground composition for approximately 1-2 minutes wherein solid carbon dioxide (snow) may be used to achieve a desired form, texture and temperature, subsequently passing the composition through a 5 mm grind plate; and forming the resulting ground composition into patties. In another embodiment, the composition may be passed through various sized grind plates and blended for more or less time. It should be noted that changes and variations can be made without departing from the spirit and scope of the invention.

What follows are results of qualitative tests performed on the preferred embodiment of the composition. Such tests were conducted to illustrate the unexpected healthy, physical and chemical properties of the resulting composition in its raw and cooked state.

Gas Chromatography/Mass Spectrometer

Headspace Gas Chromatography/Mass Spectrometry is used for the analysis of volatile and semi-volatile organics in solid, liquid and gas samples. Headspace is the gas space above the sample in a chromatography vial. Volatile sample components diffuse into the gas phase, forming the headspace gas. Headspace analysis is therefore the analysis of the components present in a sample. Volatile signature represents a high vapor pressure at ordinary room temperature. Gas Chromatography/Mass Spectrometry was used identify the volatile compounds associated with the aroma, scents, and odors of the composition.

The gas chromatography (GC) portion separates the chemical mixture into pulses of pure chemicals and the mass spectrometer (MS) identifies and quantifies the chemicals. The GC separates chemicals based on their volatility, or ease with which they evaporate into a gas. The MS is used to identify chemicals based on their structure. Typical GC tool include an injection port where a 1 microliter (1 μl, or 0.000001 L) of solvent containing the mixture of molecules is injected into the GC and the sample is carried by inert (non-reactive) gas through the instrument, usually helium. The inject port is heated to 300° C. to cause the chemicals to become gases. The outer part of the GC is a very specialized oven. The column is heated to move the molecules through the column. Typical oven temperatures range from 40° C. to 320° C. Inside the oven is a column which is a 30 meter thin tube with a special polymer coating on the inside. Chemical mixtures are separated based on their volatility and are carried through the column by helium. Chemicals with high volatility travel through the column more quickly than chemicals with low volatility.

After passing through the GC, the chemical pulses continue to the MS. The molecules are blasted with electrons, which cause them to break into pieces and turn into positively charged particles called ions. This is important because the particles must be charged to pass through the filter. As the ions continue through the MS, they travel through an electromagnetic field that filters the ions based on mass. The filter continuously scans through the range of masses as the stream of ions come from the ion source. A detector counts the number of ions with a specific mass. This information is sent to a computer and a mass spectrum is created. The data from the mass spectrometer is sent to a computer and plotted on a graph called a mass spectrum.

The GC/MS headspace analysis was done in accordance with the National Institute of Standards and Technology for identification of the compounds found in the composition. Qualitative analysis included measuring a sample of comparable raw beef and raw poultry against the present application's composition in the raw state and measurement of a comparable sample of cooked beef and cooked chicken against the present application's composition in the cooked state.

In sum, the headspace of the composition in the raw state appeared more like chicken with only a few of the “beef” volatile signatures added. By this method and rather unexpectedly, the samples are not a simple linear combination of the two meat types (beef and poultry).

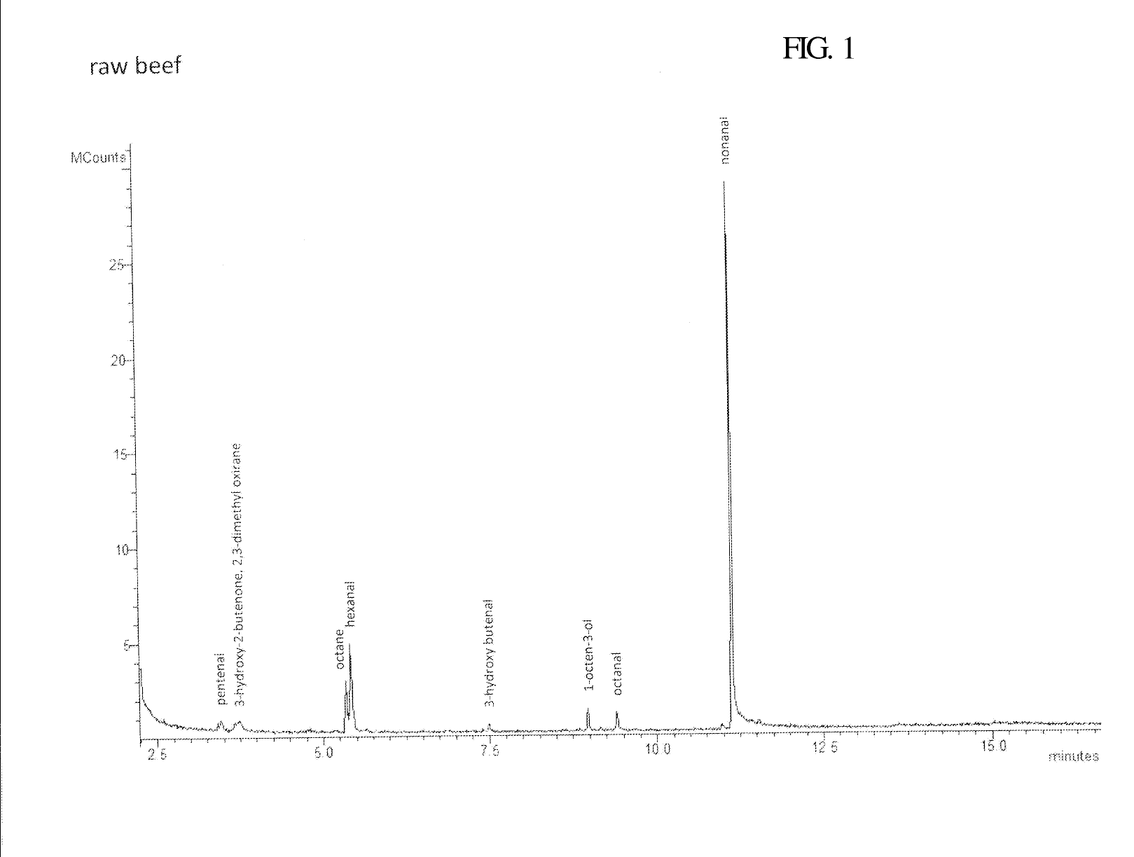

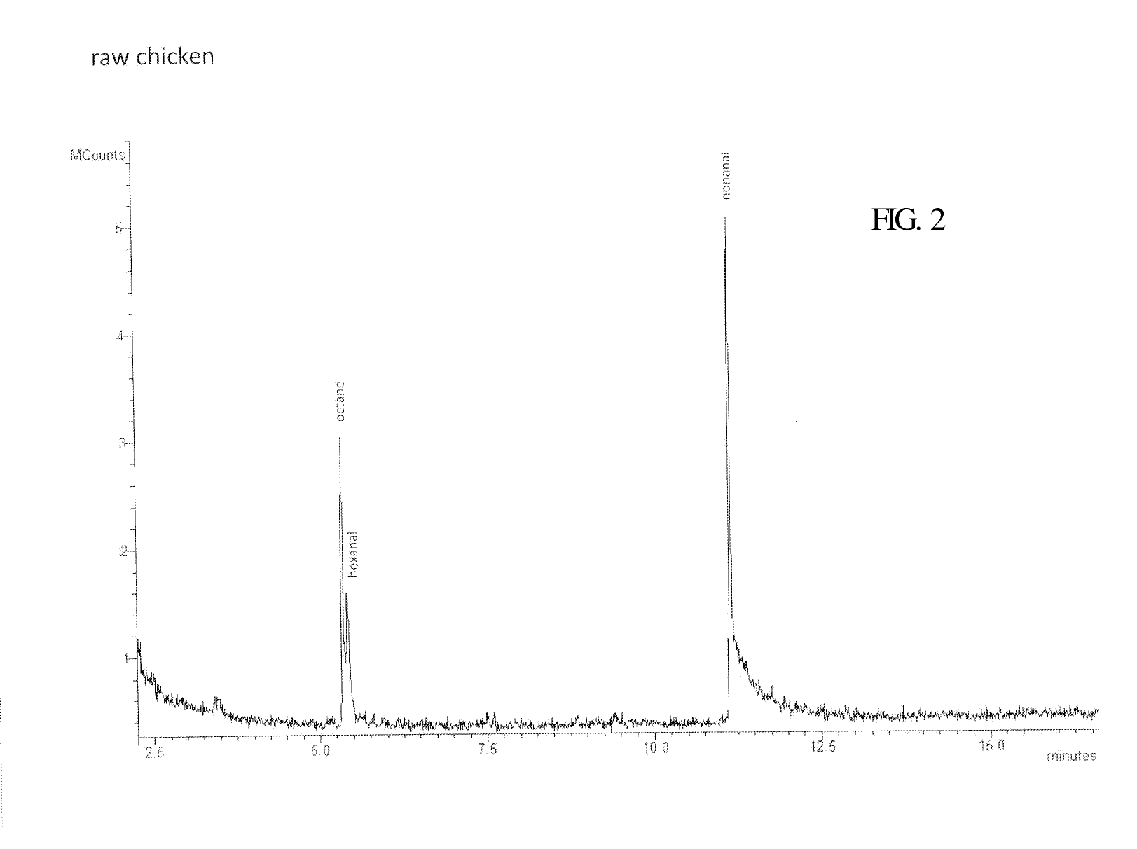

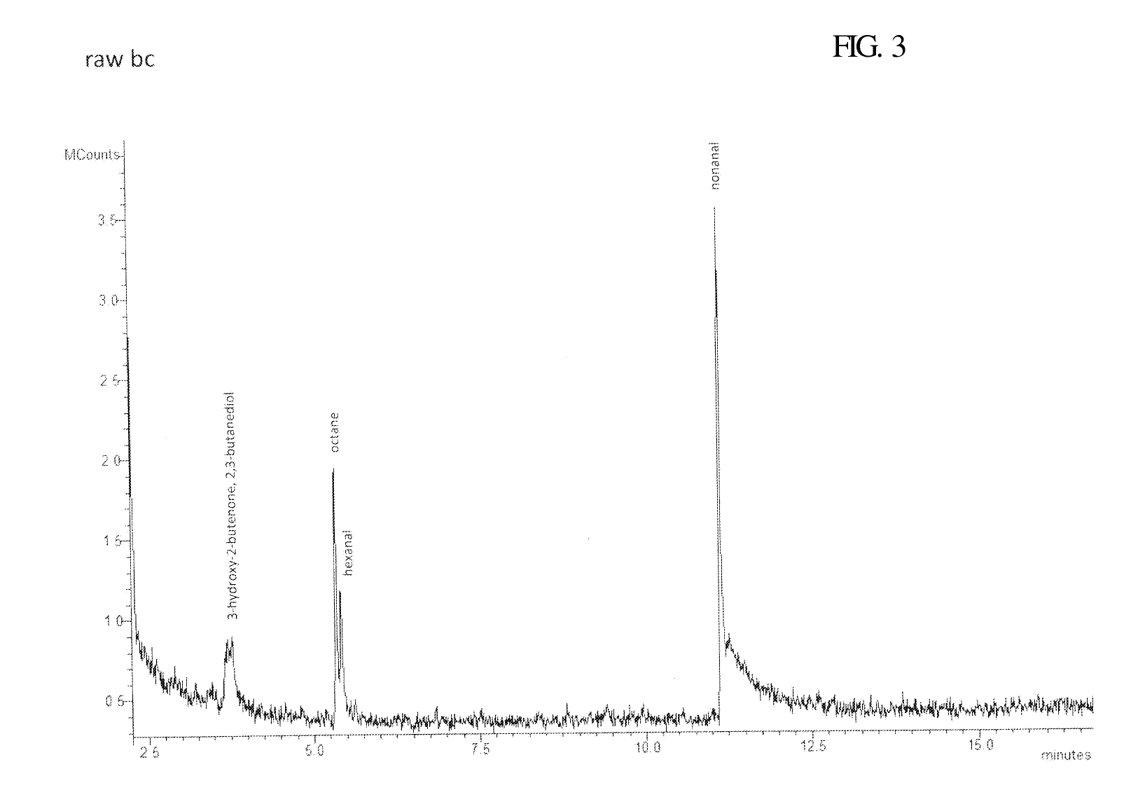

In detail, the headspace of a comparable raw beef sample (as shown in FIG. 1) showed primarily a signal corresponding to the aldehyde nonanal. This is an expected food flavor component formed through lipid oxidation reaction. Nonanal has been described in the Handbook of Meat, Poultry, and Seafood Quality (edited by Leo M. L. Nollet) as fragrant, fatty, green and having a tallow odor (FIG. 10.2 in that reference). Other volatiles were also detected with lesser intensities, mostly associated with lipid oxidation. These included hexanal, octane, 1-octen-3-ol, octanal, pentenal, 3-hydroxy butenal, 3-hydroxy-2-butenone, and 2,3-dimethyl oxirane. Other aldehydes such as hexanal, octanal and 2- or 3-methylbutanal (both pentenals) were expected in beef due to lipid oxidation. Hexanal is reported to be associated with green, grassy, and fatty odors. Pentenal has different reported odor characteristics depending on which isomer is present, although one isomer is characterized in part as burnt, pungent and toasted whereas the other is called roasted. octanal is reported as reported as soapy, sweet, fruity and nutty. The alcohol, 1-octen-3-ol is also associated with lipid oxidation, and has a green aroma. Other compounds found in the raw beef sample include 3-hydroxy-2-butenone, which is an intermediate product of the Maillard reaction normally associated with thermal decomposition in reactions between amino acids and reducing sugars. 3-hydroxy-2-butenone may have resulted from the heating of the head space vial in the analysis process. Octane has been reported in the head space of beef and is often monitored in irradiated foods. The headspace of the comparable raw poultry sample (as shown in FIG. 2) contains the largest signal of nonanal and also showed octane and hexanal. The unexpected headspace of the present application's composition in the raw state (as shown in FIG. 3) looked very much like the raw poultry with the additional peaks corresponding to 3-hydroxy-2-butenone and 2,3-butanediol.

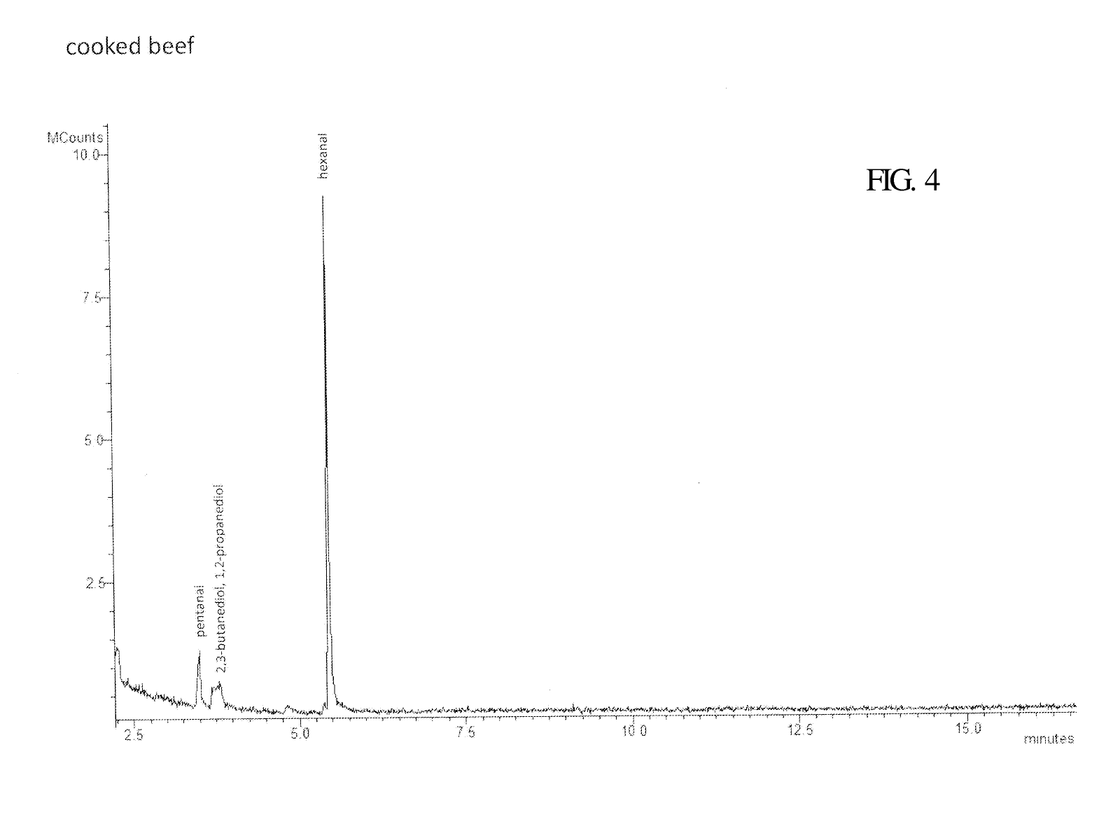

Unexpected results were also observed when measuring the headspaces of a typical cooked beef and typical poultry sample against the present application's composition in the cooked state. In the headspace of a comparable cooked beef sample (as shown in FIG. 4), the nonanal which was observed in the raw beef has been replaced with hexanal as the primary volatile in this sample. Other components include pentenal, 2,3-butanediol, and 1,2-propanediol. These diols suggest enhanced oxidation from the cooking process.

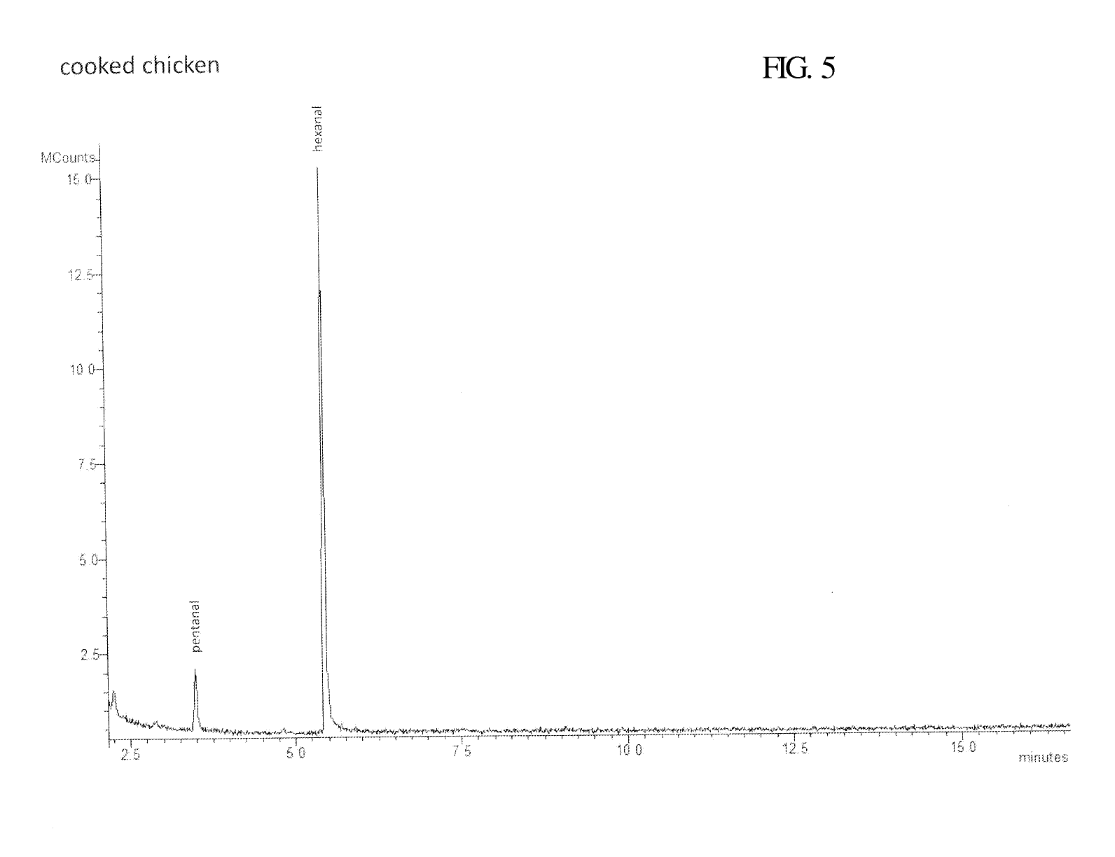

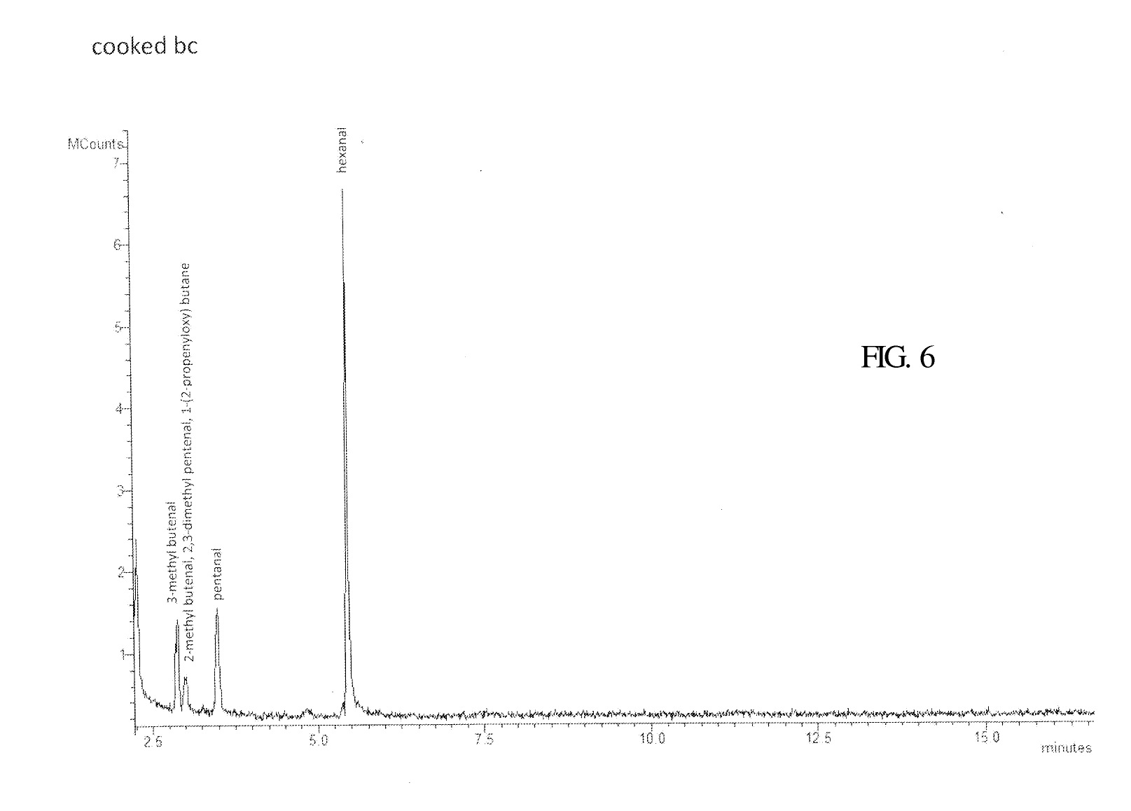

In the cooked poultry sample (as shown in FIG. 5), the nonanal has also been replaced by hexanal as the primary volatile. Neither the cooked beef nor the cooked poultry sample showed nonanal. The only other significant peak is pentanal. However, in the cooked sample of the present application's composition (as shown in FIG. 6) strong aldehydes, namely hexanal and pentanal were shown. Rather unexpectedly, the composition's headspace does not show the diols observed in the cooked beef. The unusual feature of the composition is the unique presence of compounds eluting prior to the pentanal. The composition is composed mainly of unsaturated aldehydes, and includes 3-methylbutenal, 2-methylbutenal, and 2,3-dimethylpentenal. The composition also contains evidence of an unsaturated ether, allyl butyl ether (labeled 1-(2-propenyloxy) butane (as shown in FIG. 6).

The present application's composition in the cooked state has more substantial differences than the linear combination of the individual cooked beef and cooked poultry samples. The present application's composition has a unique fingerprint that is produced primarily by volatile, early eluting aldehydes of alkenes, whereas the cooked beef and cooked chicken show only the aldehydes of alkanes and not the unsaturated aldehydes. This unexpected result was observed consistently in the replicate samples.

In summary, the headspace of the present application's composition is significantly different than the sum of the individual components after cooking. In addition to the expected aldehydes of alkanes, the present application's composition also presents new aldehydes of alkenes, specifically methyl butenals (which were observed after cooking the composition). The unpredictability of the dominance of a single aldehyde hexanal is an unexpected result and contains the flavor profile of freshly cut grass or fruity flavors.

Texture Analysis of the Compositions

The methods and materials used for the texture analysis included creating test samples of comparable raw beef and raw poultry, the composition in the raw states, cooked beef and cooked poultry, and the composition in the cooked state. The composition was thawed from being fresh frozen). Cooking of the present application's composition were done in accordance to the preferred instructions which include: thawing the composition by refrigeration if the product is frozen; pre-heating a grill to 350 degrees Fahrenheit; applying a non-stick cooking spray, cooking oil, canola or olive oil to the surface of a grill; placing the composition in patty form on grill for approximately 3 minutes; flipping the patty and cooking for an additional 3 minutes; removing the patty once the internal temperature of the patty has reached 165 degrees Fahrenheit; and allowing the patty to rest for approximately 2-3 minutes. Any other desired cooking process can be exercised and achieves the same results. The raw beef and raw chicken samples were cooked in a similar fashion.

Texture analysis methods included Texture profile Analysis (TPA) and Blunt Meullenet-Owens Razor Shear (BMORS) test. TPA is primarily concerned with the evaluation of physical characteristics of a food sample. Individual parameters of texture properties include: hardness, which refers to the Force necessary to attain a given deformation; adhesiveness, which refers to the Work necessary to overcome the attractive forces between the surface of the food and the surface of the other materials with which the food comes in contact; cohesiveness, which refers to the Extent to which a material can be deformed before it ruptures; springiness, which refers to the Rate at which a deformed material goes back to its un-deformed condition after the deforming force is removed; chewiness, which refers to the Energy required for masticating a solid food to a state ready for swallowing.

Instrumental conditions of the (TPA) test method were as follows:

Texture Profile Analysis Parameters (TPA)

| Parameter | Setting | |
|---|---|---|
| Test Speed | 3 | mm/sec |
| Test Distance | 10 | mm |
| Time between compressions | 1 | sec |

| | |
|---|---|
| Trigger Force | 0.5N |

TPA RESULTS

| Sample | Hardness | Adhesiveness | Cohesiveness | Springiness | Chewiness |
|---|---|---|---|---|---|
| Raw patties | | | | | |
| Beef | 59.04 (±16.83)a | 1.21 (±0.67)a | 0.25 (±0.00)b | 0.24 (±0.03)a | 3.55 (±0.90)a |
| Chicken | 8.84 (±2.08)c | 0.46 (±0.15)b | 0.28 (±0.01)a | 0.25 (±0.02)a | 0.60 (±0.12)b |
| Beef/Chicken | 29.16 (±10.53)b | 1.83 (±0.59)a | 0.22 (±0.03)c | 0.20 (±0.03)b | 1.29 (±0.51)b |
| Cooked patties | | | | | |
| Beef | 62.93 (±13.20)b | 0.01 (±0.01)b | 0.64 (±0.01)b | 0.76 (±0.01)a | 30.56 (±6.16)b |
| Chicken | 87.29 (±5.99)a | 0.05 (±0.01)a | 0.63 (±0.02)b | 0.74 (±0.02)a | 40.66 (±3.16)a |
| Beef/Chicken | 62.02 (±13.26)b | 0.05 (±0.02)a | 0.67 (±0.02)a | 0.73 (±0.03)a | 30.26 (±5.70)b |

In either the raw or cooked patties, different letters within the same column show a significant difference at P<0.05. The present application's composition in the cooked state was similar to the all-beef sample in terms in terms of hardness and chewiness and the composition in the raw state was similar to that of poultry in terms of adhesiveness. Here too, rather unexpectedly, the composition in either the raw or cooked state is not merely a linear combination of beef and poultry in terms.

The 2^{nd} method tested for tenderness. Instrumental conditions of the BMORS test method were as follows:

Blunt Meullenet-Owens Razor Shear Parameters (BMORS)

| Parameter | Setting | |
|---|---|---|
| Test Speed | 10 | mm/sec |
| Test Distance | 10 | mm |

| | |
|---|---|
| Trigger Force | 0.2N |

BMORS

| | | | Time to | | | |
|---|---|---|---|---|---|---|
| | Positive | Gradient to | Positive | | Negative | Negative |
| Sample | Force | Peak | Peak | Positive Area | Force | Area |
| Raw patties | | | | | | |
| Beef | 4.59 (±0.77)a | 4.78 (±0.76)a | 1.01 (±0.00)a | 277.75 (±24.73)a | 0.40 (±0.02)a | 0.15 (±0.01)a |
| Chicken | 0.74 (±0.11)c | 1.15 (±0.21)b | 0.81 (±0.18)b | 64.25 (±7.58)c | 0.16 (±0.01)c | 0.06 (±0.01)b |
| Beef/Chicken | 1.49 (±0.46)b | 1.65 (±0.52)b | 1.00 (±0.01)a | 95.83 (±19.27)b | 0.24 (±0.03)b | 0.14 (±0.03)a |
| Cooked patties | | | | | | |
| Beef | 4.96 (±1.70)a | 5.08 (±1.67)b | 1.00 (±0.01)a | 311.40 (±93.45)a | 0.23 (±0.09)b | 0.09 (±0.05)b |
| Chicken | 6.14 (±1.25)a | 7.58 (±1.16)a | 0.82 (±0.05)b | 402.91 (±67.20)a | 0.84 (±0.32)a | 0.42 (±0.19)a |
| Beef/Chicken | 2.94 (±0.92)b | 3.21 (±0.75)c | 0.94 (±0.09)a | 189.56 (±47.83)b | 0.10 (±0.04)b | 0.03 (±0.02)b |

In either the raw or cooked patties, the different letters within the same column show a significant difference at P<0.05. The positive force represents the shear force necessary to attain a given deformation. The positive area represents the shear energy necessary to attain a given deformation. The present application's composition in the cooked state were significantly lowest in shear force (i.e., positive force) and shear energy (i.e., positive area) among the three samples in the cooked state. Based on the TPA and BMORS tests and rather unexpectedly, the composition in the cooked state appears to be softer than that of the individual cooked beef and cooked poultry samples.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. An edible food composition, including:
a combination of portions of ground beef and ground poultry; the combination having from 5-95% by weight of ground beef and 95%-5% by weight of ground poultry.

2. The composition of claim 1, wherein the ground beef is derived from the chuck section of a cow.

3. The composition of claim 1, wherein the ground poultry is derived from the leg of a chicken.

4. The composition of claim 1, wherein the ground beef is derived from various sections of the cow.

5. The composition of claim 1, wherein the ground poultry is derived from various parts of a chicken.

6. The composition of claim 1, wherein the combination is comprised of 10%-90% of ground beef and 90%-10% of ground poultry by weight.

7. The composition of claim 1, wherein the combination is comprised of 20%-80% of ground beef and 80%-20% of ground poultry by weight.

8. The composition of claim 1, wherein the combination is comprised of 30-%-70% of ground beef and 70%-30% of ground poultry by weight.

9. The composition of claim 1, wherein the combination is comprised of 40%-60% of ground beef and 40%-60% of ground poultry by weight.

10. The composition of claim 1, wherein the combination is comprised of equal portions of ground beef and ground poultry by weight.

11. The composition of claim 1, wherein the combination is comprised of unequal portions of ground beef and ground poultry by weight.

12. The composition of claim 1, wherein the composition elutes a volatile signature of nonanal in the raw state similar to that of poultry.

13. The composition of claim 1, wherein the composition elutes a volatile signature of hexanal and methyl butenal in the cooked state.

14. The composition of claim 1, wherein the composition has approximately 52% less fat, 35% less calories and 55% less saturated fat than that of ground beef.

15. The composition of claim 1, wherein the ground beef and ground poultry is in a raw state.

16. The composition of claim 1, wherein the ground beef and ground poultry is in a cooked state.

17. The composition of claim 1, wherein the composition is lower in fat, saturated fat, calories and calories from fat than beef.

18. The composition of claim 1, wherein the composition contains high amounts of omegas 3, vitamin A and E, oleic and linoleic acids, retinol and calcium.

19. The composition of claim 1, wherein the ground beef and ground poultry is derived from grass fed cows and chickens.

20. The composition of claim 1, wherein the ground beef and ground chicken is derived from chicken and cows free of antibiotics, hormones and genetically modified organisms.

21. The composition of claim 1, wherein the ground beef and ground poultry is free of additives, fillers and preservatives.

22. The composition of claim 1, wherein the hardness of the composition is similar to that of beef.

23. The composition of claim 1, wherein the chewiness of the composition is similar to that of beef.

24. The composition of claim 1, wherein the composition in a cooked state has a shear force and shear energy lower than that of cooked beef or cooked poultry.

25. The composition of claim 1, wherein the composition in a cooked state is lower in positive force and positive area than a linear combination of beef and poultry.

26. The composition of claim 1, wherein the ground beef and ground poultry is in a frozen state.

27. The composition of claim 1, wherein the ground beef and ground poultry is in a refrigerated state.

28. A method of preparing a ground beef and ground poultry composition including:
initially passing the equal portion of poultry and beef through a 3/16″ grind plate,
blending the ground composition for approximately 1-2 minutes using solid carbon dioxide to achieve a desired form, texture and temperature, and subsequently passing the composition through a 5 mm grind plate.
